(19) United States
(12) Patent Application Publication
(10) Pub. No.: US 2024/0408558 A1
(43) Pub. Date: Dec. 12, 2024

(54) SELF STIRRING SYSTEM FOR COOKWARE AND OTHER APPLICATIONS

(71) Applicants: Teri Miller, Santa Cruz, CA (US); Nick Miller, Santa Clemente, CA (US); Brandon Jansen, Brookdale, CA (US)

(72) Inventors: Teri Miller, Santa Cruz, CA (US); Nick Miller, Santa Clemente, CA (US); Brandon Jansen, Brookdale, CA (US)

(73) Assignee: Stirware Corporation, Santa Cruz, CA (US)

(21) Appl. No.: 18/648,919

(22) Filed: Apr. 29, 2024

Related U.S. Application Data
(60) Provisional application No. 63/498,534, filed on Apr. 27, 2023.

(51) Int. Cl. B01F 27/051; B01F 27/11; B01F 35/22

(52) U.S. Cl. CPC B01F 27/051; B01F 27/11; B01F 35/22

(57) ABSTRACT

A stirring/mixing device is provided, comprising a container and a motorized stirring element that permits substances within the container to be stirred without an attendant. In a preferred embodiment, two blades are provided that are shaped to push material away from the wall of the container and fold the substances together so as to provide a substantive mixing of whatever is placed within the container. The device can be configured so that mixing is controlled by a panel or remote control and the speed and direction can be adjusted, such that proper mixing is achieved without direct supervision. To provide proper force, the blades can be attached on a gear drive that rotates about the opening of the container

### RELATED APPLICATIONS

The present application is a non-provisional application taking its priority from U.S. Provisional Patent App. No. 63/498,534, filed Apr. 27, 2023, which is hereby incorporated by reference as if set forth in its entirety herein.

### FIELD OF THE INVENTION

The present invention concerns a device that stirs substances in a container, as either part of the device or within a separate containment element. More particularly the present invention concerns a stirring system that particularly folds and stirs food in a cooking vessel, while it is being heated or otherwise acted upon, so that constant attention to the vessel, by an attendant, is unneeded. It will be understood that the actions of the present device can be performed on substances other than food, as well, as will be discussed in greater detail below.

### BACKGROUND OF THE INVENTION

Busy cooks in homes and restaurants find that there are recipes that require that substances being heated be continuously moved about the cooking vessel to avoid such occurrences as the scalding of the ingredients being heated. Other occurrences, in similar situations, includes the boiling over of the pot and the improper mixing of the elements therein; among other situations known to cooks and persons having ordinary skill in the art. It will also be understood that a need for constant motion of substances being mixed can be identified in other fields, such as pharmaceuticals, chemicals, materials (plastics, concrete, asphalt, and others) where aspects of the presently existing problem, and its solutions, arise.

We have found that there is a current need for a device that can stir substances continuously in a variety of situations. While the present invention is directed to an appliance for use in cooking, it will be understood that by virtue of its inventive elements, the device can be used for other types of mixing and stirring without departing from its novel concept; however, it will be further understood that in the art of such mixing, the present invention is novel and not shown or made obvious by present-day devices.

Presently, stirring systems in cooking, particularly for pots, are designed to help alleviate the dilemma of multitasking, that often confronts cooks in the kitchen. All too often certain recipes require constant or near constant stirring. Generally, there are three main reasons for stirring that fit almost every such situation; 1) to create a homogenous mixture, 2) to evenly disperse temperature and 3) to alter the viscosity of the liquid. Experts have found that when stirring, there is a need for a utensil that can reach the bottom and all corners of the vessel and there needs to be an understanding of such requirements, in a recipe, that says “stir occasionally” or “stir frequently” to understand what the intended result of the stirring is, to ensure that stirring is properly performed. But oftentimes, stirring is not the only thing a cook has on his or her agenda.

In a modern kitchen, both in the home or a restaurant or commissary, it is often the case that the cook cannot merely stir and do nothing else; in the home, there are often distractions caused by children, pets, company or visitors and telephone calls or other messages. These distractions can exist in commercial kitchens as well, in the form of new orders being received, the needs of other elements of a meal, business and employee issues, clientele, vendors, health officials as well as natural events interfering with the course of actions being handled as well as calls and messages. Such events are endemic in any of the previously mentioned employments of stirring projects in various industries.

For cooks, the problem with stirring constantly often occurs when making dishes like risotto, oatmeal, jams, cheese sauces, chocolate sauces or anything that requires frequent or constant stirring in order to avoid scalding of the food. In the home, or at a business, it is often the case that the cook, during meal preparation, also wants to visit with family or friends/guests for whom they are cooking, or handle household or business issues, which can cause a terrible predicament for the cook. This stirring dilemma also arises when the cook is multi-tasking, making several stir intensive recipes or even when the telephone rings, a message is received or household tasks must be attended to. Other issues arise for persons having disabilities that do not allow them to stand at a stove, or other cooking implement, to accomplish the stirring needed to properly prepare the substance being created. In the world of industry, persons having disabilities are often kept from such work because they do not have the ability to stir substances constantly and consistently and are therefore kept from all the aspects of such employment: to wit, if you cannot stir the substances, you cannot be a cook.

At its core, this invention solves the problems associated with recipes that require constant or near constant stirring by replacing the human hand with a completely automated system. This particular system and components are designed so that the stirring is even, smooth and not overly aggressive such as not to ruin or disturb the sanctity of the recipe. In fact, the automated stirring system of the present invention might actually be better than an actual cook since the stirring it is designed to perform is likely to be more thorough and consistent, with just the right even, continuous stirring motion. Therefore, the present invention allows the cook to leave the cooking pot and be able to tend to other cooking tasks or to spend time with the family or guests. The present invention prevents the meal from being ruined, which can happen in a matter of minutes if stirring should be halted for whatever reason. The present invention can also assist those cooks that suffer from arthritis or other physical disabilities or challenges that make stirring or even standing in place while stirring challenging, problematic, or impossible.

### The State of the Art

There are devices that stir in the marketplace, but they are inferior to the inventive stirring solution disclosed herein. These devices are designed to be universal fit, and they do not completely wipe all surfaces or move food materials completely, smoothly, and consistently. What ends up happening with current devices is that the food within the pot sticks, does not fold properly and usually ends up with spot burning and inconsistent viscosity. Further, these currently available devices created as standalone tools can easily fall over, require plugging in, and are not easily moved around. Additionally, the other currently available stirrers, created as detachable accessories that are clamped in place, do not sit securely onto the pot, can easily slip, dropping the device into the food being prepared, making the food unsanitary. The currently available stirrers are just not good enough, especially for recipes that require a smooth and consistent stirring action.

Finally, the stirring system of the current invention can be managed as part of a smart home system and can therefore be operated and managed remotely. This is particularly important as smart home technology is poised to make a 50% increase in accessibility by 2030 with price points driving market adoption in more than 85% of US households. The stirring system herein described will be among these new devices in smart cookware technology that solves a particularly acute issue but have an approachable price point.

Objects and advantages of the present invention will become apparent as the description proceeds.

### SUMMARY OF THE INVENTION

In accordance with the present invention, a self-stirring system is provided for use with a container on, typically, a heat source. The system comprises a container, having an interior portion having an inner surface comprising a continuous wall of a desirable height and a floor, for holding one or more substances to be mixed. A stirring element is provided, having a motive means and at least one dependent blade for folding together one or more substances within the container, the dependent blade having a blade profile comprising an advantageous length and width such that an element of the blade profile is in continuous contact with the inner surface wall of the container and is contiguous with the inner stirring surface floor of the container, to substantially continuously mix the substance for a desired time while the substance is affected by the heat source. In a preferred embodiment, the motive means include a motor and gear assembly and the at least one blade is a first blade and a second blade, each of which being advantageously placed to affect a volume of the one or more substances to be mixed.

In some embodiments the first blade comprises an element having several surfaces configured to lift and fold the one or more substances to be mixed. For best results, the second blade comprises a flexible element configured to continuously contact the inner surface of the container along its entire height, so as to cause the one or more substances to be mixed to be pushed off of the wall, and a volume adjacent the wall, and towards the first blade.

In some embodiments of the present invention, one or both of the first blade and the second blade includes a foot element, adjacent to the floor of the container, to lift the one or more substances to be mixed from the floor of the container so as to better mix the one or more substances to be mixed. In a preferred embodiment, the first blade and the second blade are attached to a toothed gear ring, sustained about the top circumference of the container, in mechanical engagement with the motive means, to cause the first blade and the second blade to effectually rotate about the interior portion of the container.

In preferred embodiments the stirring element is controllable by a remote control device, such that the rotation of the at least one dependent blade can be at least started, sped up, slowed down, reversed or stopped remotely. In most embodiment, the stirring element is controlled by a control panel on the device.

The self-stirring system of the present invention can be configured with a container, having an inner surface comprising a generally horizontal surface and a cylindrical surface generally perpendicular to the generally horizontal surface, for holding substances to be mixed. The stirring element has a motive means, comprising a motor and gear assembly controlled by a panel on the self-stirring system, and at least one dependent blade for mixing a substance within the container, the dependent blade having a blade profile comprising a suitable length and width such that an element of the blade profile is in continuous contact with the inner cylindrical surface of the container and is contiguous with the generally horizontal surface of the container, to substantially continuously mix the substance for a desired time. The at least one dependent blade is a first blade and a second blade, attached to a toothed gear ring, sustained about the top circumference of the container, in mechanical engagement with the motive means, each blade being advantageously placed to affect a volume of the one or more substances to be mixed. The system, in some embodiments has a first blade that has an element having several surfaces configured to lift and fold the one or more substances to be mixed and a second blade having a flexible element configured to continuously contact the inner surface of the container along its entire height, to cause the one or more substances to be mixed to be pushed off of the wall, and a volume adjacent the wall, and towards the first blade.

In a preferred embodiment, one or both of the first blade and the second blade includes a foot element, adjacent to the floor of the container, to lift the one or more substances to be mixed from the floor of the container so as to better mix the one or more substances to be mixed. The stirring element is controllable by a remote-control device, such that the rotation of the at least one dependent blade can be at least started, sped up, slowed down, reversed or stopped remotely.

### Additional Aspects of the Present Invention

The present design is engineered to cleanly and consistently wipe all surfaces and incorporate fluid dynamics to completely mix the entire contents of the pot during the stirring action. The present design, namely the new and novel stirring blade design, keeps the contents of the pot moving, not only around the pot, but also from bottom to top and from the inside out. The present design incorporates a special transparent lid, allowing for stirring constantly with a lid in place—a feature that appears to be a need in the marketplace that many cooks performing certain recipes would benefit from immensely by keeping flavors rich and textures consistent.

The present stirring system utilizes a specially designed motor and stirring implements (blade or paddle) that is submerged in the pot. The present stirring mechanism uses a single concentric drive and allows for future modifications that would enable stirring motions that range from simple to complex.

Parallel with the benefits of the present stirring system described above, another primary purpose of this stirring is to mix the contents for homogeneity. The other purpose addressed by this invention is to avoid burning from stagnation on the cookware surface. Liquid media is most forgiving as it flows freely and conveys heat throughout the bulk volume easily. More viscous liquids especially colloids and solids need more direct manipulation.

Viscous media will stick to the cook surface and requires a clean wipe or scraping action to lift from the surface. To accomplish this, the present stirring/scraping blade (or paddle) is preferably made of a compliant silicone rubber or plastic scraper with an interference fit to the pot surface. A more conventional trailing wiper design will work sufficiently for a variety of cooked media and is preferred from a drive torque and wiper buckling stability standpoint. However, a trailing wiper is susceptible to “painting” viscous media or “push-brooming” solid foods—both of which lead to burning or subpar mixing or consistency. The negative rake angle of the wiper/scraper of the present design is an improvement that avoids burning. Both styles of these blades are described further below and shown in the accompanying drawings.

A point of concern for a single concentric drive is that at the center axis on the bottom of the pot there exists a stagnation point where food sticks and then may burn. Although burning at the center point has not proven to be a significant concern, the adaptation of using a slight eccentric or epicyclic drive along with a more compliant scraper drive mechanism to take up the eccentricity at side surfaces eliminates the center stagnation point.

Another point of concern for burning is the circumference of the upper food surface. Several design features of the present stirring system that address this area: a compliant interference contact wipes and lifts food clean from the pot to be mixed in with bulk volume. Stirring motion of viscous content creates a “bow wave” of food ahead of the wiping blade, a downward attack angle and rake angle minimize the bow wave from overcoming the height of the wiper and being left stagnant to burn or develop a crust.

One will see in the configuration of the blades, that the present inventive solution can stir fluids as well as sauté heterogenous solid pieces well. A backward swept sickle shape scraper is used along the bottom surface. This geometry drives food to the cylindrical side of the pot thereby using the pot wall as an opposing surface to lift food up and over the scraper. Also, the sickle blade stops short of the pot corner so that food (such as melted chocolate, rice, sauces and the like) has an “escape” path for whatever food product may have piled up in a push broom fashion.

The present invention also uses a ring gear as opposed to a traditional center post driving source to avoid the difficulties of being able to add ingredients or taste the food as it is being cooked. A large diameter ring gear is used to allow better access and visibility into the pot. More common implementations use direct drive from the center, but that creates an obstacle for seeing, adding ingredients, or tasting.

### DESIGN FEATURES OF THE PREFERRED EMBODIMENT OF THE CURRENT INVENTION

The pot is stainless steel with a flat bottom, smooth sides (no rivets or side protrusions) and radius corners.
Double use lid: with and without stirring ring.
The lid is transparent for full view of the contents within.
The handles are configured to receive the quick-release locking mechanism that holds the stir ring in place and which ensures perfect alignment between the pot surfaces and the blades.
The stirring attachment runs on a circular track around the top rim of the pot.
The blade assembly wipes the side and bottom completely to avoid clumping and spot thickening.
The bottom blade flips food to avoid burning while cooking and sautéing.
The center blade incorporates several vectors of fluid dynamics to blend ingredients better than the user could do with a manual utensil.
Stirring speed is continuously variable, selected by the user.
The present stirring system can operate on internal battery power (no external wiring over the cook surface) or, for cook surfaces that don't present a fire hazard, it can remain plugged into an external power source for unlimited stirring time. As an option, the design includes an optional companion heating element for close-coupled or combined cooking and stirring control.
The present inventive pot has an onboard display for time, temperature, and other information relevant to the user.
Submerged temperature sensors can be included.
Wireless data interface to connect to remote (or smart) user device such as a phone for remote monitoring and control.
Onboard controls for start/speed/stop
Blade design
   Positive contact between blades and cooking surface
      For sauces, the advantage of wiping clean and not leaving a dried/burnt ring at the top around the pot
      For sautéing it is to get underneath the cooking food to agitate it or flip it over without just plowing it around in a circle.
Flexural design as a single solid piece with no moving parts for simplicity, cost, and ease of cleaning. Flexure maintains light preload between blades and inner surface of the cooking vessel while remaining compliant given all the thermal expansion issues that may arise from the heated cooking vessel and blade.
Construction materials
   Nonstick or ceramic pot would have silicone over molded edging (elastomer or thermoplastic)
   Stainless steel may just be stainless steel blade edge.
2 blade arrangement
   Center blade gives an outward and upward agitation to the food
   Outer blade gives an inward and downward agitation to the food.
      By separating the blades, by examining the sweeping radial cross section of the blades at any point, it demonstrates that the blade engages food but also always allows it somewhere to flow to. Food gets agitated but also passes through without being plowed into a pile up.
   Not all cooking recipes will require both. Can operate with bottom, side, or both.
Negative rake angle on both contact surfaces
   Advantage is a scraping action instead of painting to get underneath the food.
   The reaction forces from stirring food reinforce blade contact against the inner surface of the cooking vessel.
The bottom stirring blade has a backward sweeping sickle shape
   As it rotates, it creates a wedging force to any food morsel between the blade and the inner cylindrical surface of the cooking vessel. The surface friction force between food and the pot that is created by stirring rotation gets amplified into the wedge shape which in turn lifts the food up and over the blade to result in the ‘flip’ for sautéing as an example.
Attachment of blades to housing.
   Magnetic retention or click to connect (e.g. ball and socket)
      A preferred embodiment would be 1 or more narrow wedge, cone, or keyhole shapes whose engagement vector is opposite of the stirring direction. When aligned into a matching mating feature this joint creates a rigid connection.
      Any internal edge (e.g. the ‘point’ of the wedge or cone) is rounded to a large enough internal radius to be wiped and cleaned easily.
      Embedded within the mating sphere shapes are 1 or more magnets which attract and statically retain the blade to engage the wedge feature. While stirring the wedge feature is forced preloaded further into its socket thereby reinforcing the joint during dynamic loading of stirring. This attachment is released with the minimal static force to overcome the retaining magnet.
      A similar design can be imagined but with a sphere and socket that are slightly larger than tangent to the wedge feature. This slightly larger ball feature can be forced into engagement with a detent click into the socket and similarly released. This embodiment eliminates the need for magnets to maintain the static loading attachment.
      The protruding feature can exist either on the stirring or the blade side.
      For ease of use to connection can be made or released without the use of tools
      For cleanliness concerns this design has no moving parts such that no faying surfaces or hidden spots exist that can not be easily cleaned.
Attachment of housing to pot
   Similar motivations apply to the blade attachment: Toolless, no moving parts, dishwasher safe for ease of use and cleanliness.
   A preferred embodiment would use the top circular lip of the cooking vessel as a primary interface datum. This datum is best to control the centering position and the height of the stir mechanism relative to the cooking vessel. Light contact between the stirring blades and the cooking surfaces of the vessel is an important dimensional control that provides best performance so this alignment is key.
   Pot handles may come as knobs, or T or U-shaped handles (and a variety of other options). Preferred embodiment is a U-shape handle.
   Controlling alignment is also important when considering reaction forces from stirring. Torque and lifting out of the pot are not controlled by interfacing to the top circular lip of the pot. For those another salient feature is needed. A preferred embodiment of these retention features is protrusion from the stir ring housing that nestles into or around the pot handle openings. Engagement in or around the pot handles provides a positive connection that reacts the stirring torque without relying on friction like some other designs that engage or clamp only to the cooking vessel's cylindrical surfaces. Downward retention is achieved by flexural tabs that wedge underneath the pot handles. The contact area that the retention tab covers still allows use of the handles while connected either by creating a handle like form itself or by leaving a usable portion of the U-shape handle un-obstructed. Release is achieved by pressing and deflecting the retention tab flexure inward and lifting the housing upward and out of the handles.
   Other connection options:
      Attach to pot handles or attach to specific features added to cooking vessel like a pin to clip onto
      Clamp to rim of pot which is flared out. The clamp force resists the stirring torque and engagement under the flare out lip of the pot provides a positive contact Lever cam lock, Marmon clamp, band clamp, wedge lock or pure friction
Control
   The stirring motion is continuously variable speeds and can also be coordinated to follow speed patterns (e.g. stop/start, pulse). A database of prescribed or automated recipes can be deployed to a user device and downloaded or directly controlled from the user device to the stir ware.
   Physical controls are located onboard the device for simple controls when the more advanced remote device controls are not used. An on/off slide or toggle switch is available to shut off the device in case of possible communication faults.
   The stir ring is shaped in a way that the upper portion is funneled outward over the ring gear and bearing mechanism. This aids in directing ingredients being added into the cooking vessel but it also makes available a rotating touch surface for the user to control stirring speed. Capacitive touch/swipe gesture device is located on the top side of this funnel feature of the stir ring.

A more detailed explanation of the invention is provided in the following description and claims and is illustrated in the accompanying drawings.

### BRIEF DESCRIPTION OF THE DRAWINGS

FIG. 1 is a perspective view of a preferred embodiment of the device of the present invention in a closed configuration.

FIG. 2 is an exploded perspective view of the device of FIG. 1.

FIG. 3 is an exploded perspective view of the stirring unit of the device of FIG. 1.

FIGS. 4A, 4B, 4C, 4D, 4E, 4F, 4G, 4H are views, from various perspectives, of elements of various aspects of the device of the present invention.

FIG. 5 is a front perspective view of a stirring/folding element of the device of the present invention.

FIG. 6 is a right-side perspective view of a stirring/folding element of the device of the present invention.

FIG. 7 is a top perspective view of a stirring/folding element of the device of the present invention.

FIG. 8 is a left-side perspective view of a stirring/folding element of the device of the present invention.

FIG. 9 is a rear perspective view of a stirring/folding element of the device of the present invention.

FIG. 10 is an exploded perspective view of the exterior of a device of the present invention.

FIG. 11 is an exploded perspective view of the exterior of another embodiment of a device of the present invention.

FIG. 12 is an exploded perspective view of the exterior of another embodiment of a device of the present invention.

FIG. 13 is an exploded perspective view of the exterior of another embodiment of a device of the present invention.

FIG. 14 is an exploded perspective view of the exterior of another embodiment of a device of the present invention.

FIG. 15 is a perspective view of a remote control for use with the device of the present invention.

FIG. 16 is a perspective view of a control panel of the type used to control the action of the present invention.

FIG. 17 is a perspective view of a communication device showing an “App” comprising a control panel of the type used to control the action of the present invention.

### DETATLED DESCRIPTION OF THE ILLUSTRATIVE EMBODIMENT

While the present invention is susceptible of embodiment in various forms, there is shown, in the drawings, several presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description of an Illustrative Embodiment”) relates to a requirement of the United States Patent Office, and should not be found to limit the subject matter disclosed herein.

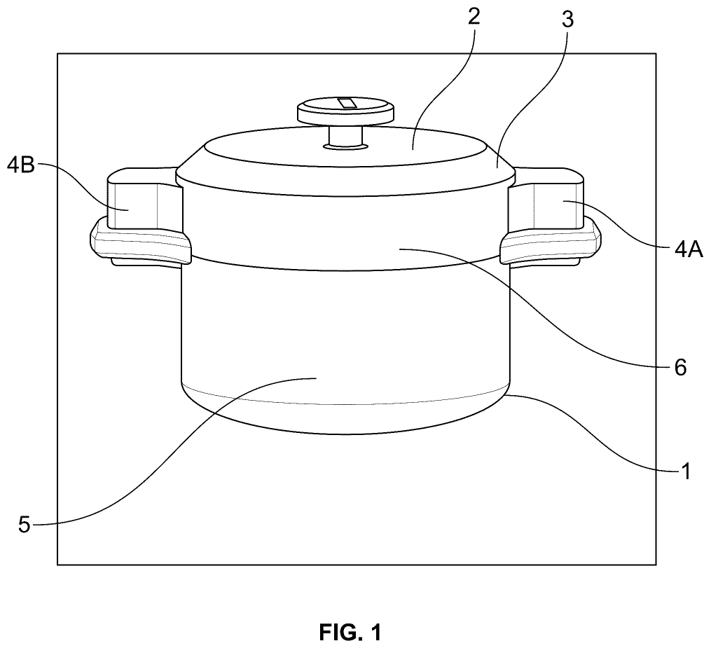

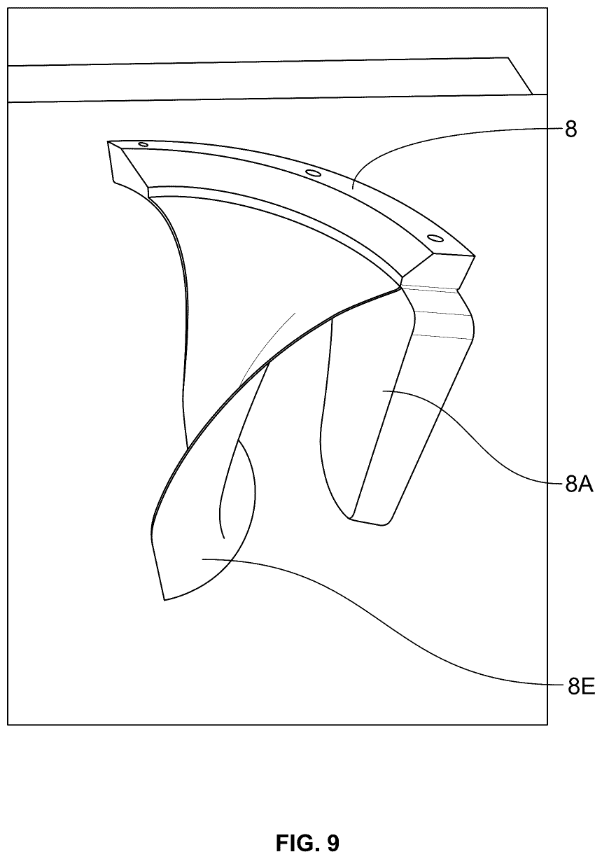

The following detailed description of the preferred embodiments of the present invention references the attached FIGS. 1 through 9 and alternative embodiments in FIGS. 10 thru 14.

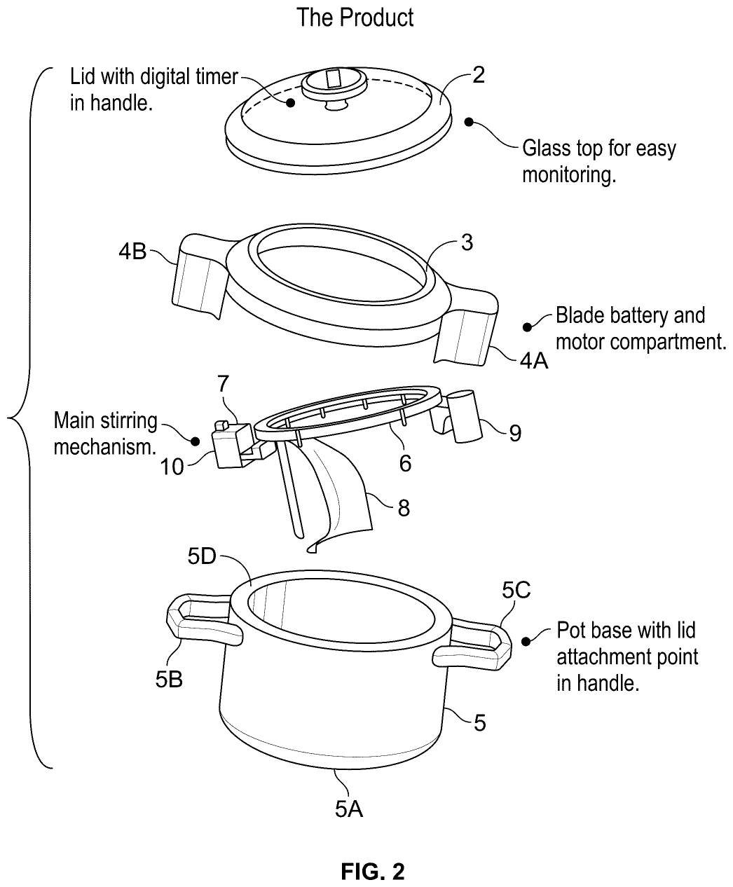

Referring now more specifically to FIG. 1, there is shown the cooking pot 1 of the present invention, known by its brand name STIRWARE™ which is a product of Stirware Corporation of Santa Cruz, California, and is referenced generally in this figure and throughout the figures, at reference numeral 1. In FIG. 2, there is shown more particularly the main components of the device: a see-through cover or top 2, a battery and motor holding ring or mount 3, which has incorporated therein at opposing sides, a battery compartment 4A and a motor compartment 4B. The compartments 4A and 4B are configured to house their respective nominal key components—a power source such as a blade battery and a driving or motor source. The power source is preferably a battery or whatever type of power source that can fit into a compartment 4A. It should be noted that the compartment 4A can be configured in other ways such as to house different power sources, having other shapes and sizes not herein disclosed, and include such things as a power port for the attachment of electrical current, all without departing from the novel scope of the present invention. Similarly, the motor source may consist of various types of off the shelf or specifically designed motors that can provide sufficient and consistent power to drive the stirring mechanism later described herein. The invention is not in the specific power or motor source, but in the configuration of mount 3 such that these items are housed or incorporated into mount 3, such that they are not exposed or protrude, and do not impede the cook in some manner, and are not in the way and are aesthetically incorporated into the present cooking pot 1. They are, of course, essential components to drive the stirring system, but the goal is to protect them and make them virtually hidden to the user.

The present stirring system can operate on internal battery power (no external wiring over the cook surface) or, for cook surfaces that do not present a fire hazard, it can remain plugged into an external power source for unlimited stirring time. Note that it is preferred that the cover is completely or at least partially see-though and thus made of any see-through material such as glass or other materials that are food safe and can sustain high cooking heat.

Continuing with reference to FIG. 2, there is depicted the pot base 5, which includes, a bottom 5A, opposing handles 5B and 5C and a top perimeter or lip 5D. There is also depicted the main stirring mechanism 10 that consists of the mounting or main ring plate 6 that is itself configured to have mounted or otherwise integrally attached the main motor source 7, stirring blade or paddle 8 and a battery or power source 9. The handles 5B and 5C are designed and configured to receive within the periphery of each handle the compartments 4A and 4B so that when the mount 3, comprising main ring plate 6 and main motor source 7, coupled to the underside of mount 3, and mount 3 is placed onto the lip 5D of the pot base 5, the pieces, 2, 3, 5, 6 and 7 will fit or stack together to form the present cooking pot 1 (as shown best in FIG. 1).

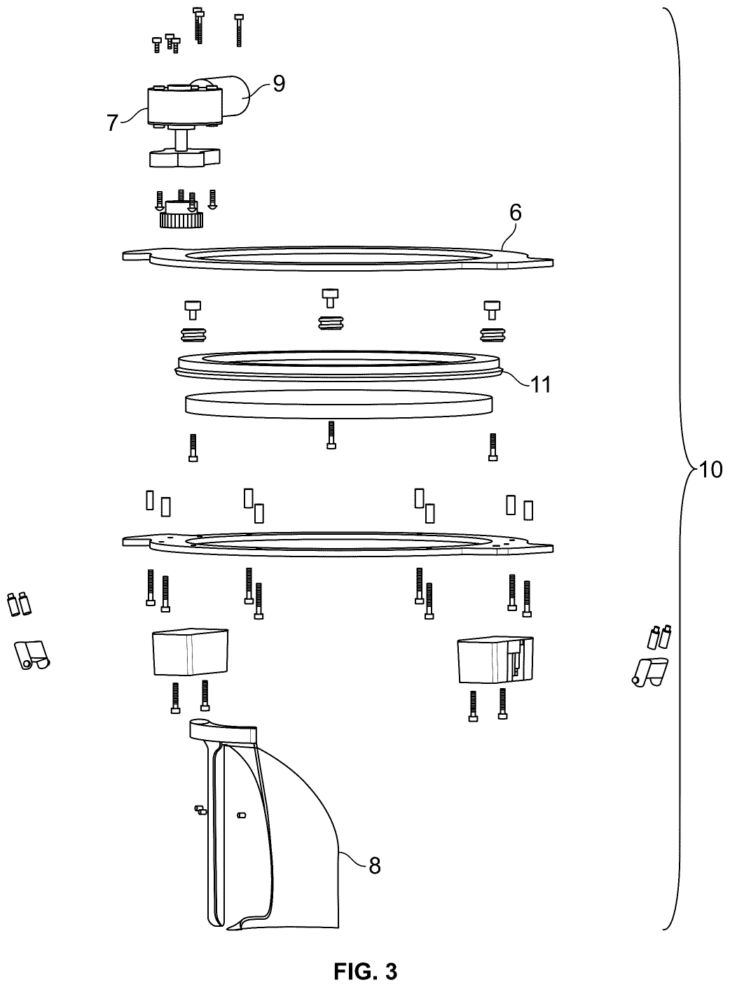

FIG. 3 is an engineering CAD drawing showing, in an exploded view, the main ring plate 6 and motor source 7, as previously described in reference to FIG. 2. Notable in FIG. 3 is ring gear 11 which drives the stirring system 10. The power source 9 provides electricity to the motor source 7 which in turn drives the ring gear 11 which then drives or moves the blade 8 around the inside of the pot base 5. The illustrated embodiment of the present invention uses ring gear 11, as opposed to a traditional center post driving source, to avoid the difficulties of having a motor drive at the center of the opening of pot 5, to allow the user ease in adding ingredients, or tasting the food, as it is being cooked. A large diameter ring gear 11, therefore, is preferred as it allows better access and visibility into pot base 5. Rather than using a common direct drive from the center, ring gear 11 removes an obstacle that is present in prior available stirring mechanisms. The ring gear 11 also tends to create a smoother and more consistent stirring action in the pot as it moves the blade around the inside of the pot base 5. The stirring is therefore effectuated by the mechanism that runs on a circular track around the top rim of the pot 1.

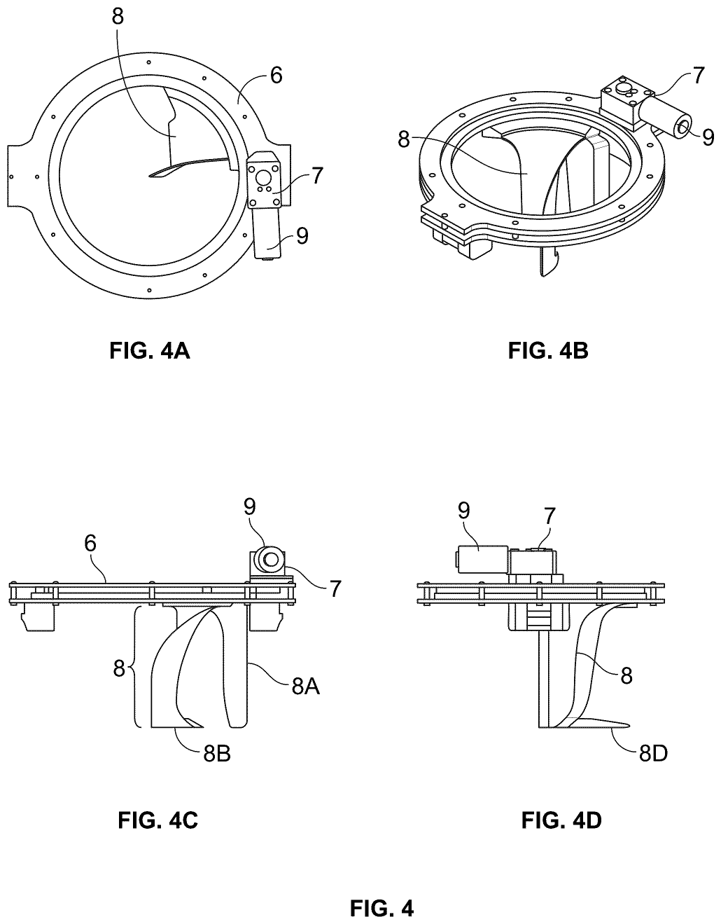

Turning now to FIGS. 4A-4H, all shown together on one page, there is shown, in different perspective views, some of the main components of the present invention. There is shown in greater detail the main ring plate 6, along with the pot base 5, bottom 5A, opposing handles 5B and 5C and a top perimeter or lip 5D, the main motor source 7 and stirring blade or paddle 8. The blade assembly 8 itself is shown in more detail in FIG. 4 as it shows the two blade arms 8A and 8B. Blade arm 8A is shown to be in position to wipe the inner side surface 12 of pot base 5 and blade inner arm 8B (including the bottom scraping blade section 8D as shown best in FIG. 4D, act to wipe the inside bottom surface 13 of the pot 5, with each rotation, to avoid the tendency for food to clump and help to avoid localized thickening, common when stirring devices only stir the interior of a pot. The main structure of blade inner arm 8B works together with blade inside arm 8A to create the inventive stirring motion acting to push, flip, and fold the contents of the pot. The inner arm blade 8B in motion causes several vectors of fluid dynamics to blend ingredients better than the user could do with a standard manual utensil.

The scraping blade section 8D is shown herein as a backward sickle shaped scraper, but it is envisioned that many other designs could be used here, without departing from the novel scope of the present invention. The critical feature of the design of blade section 8D is to provide for a geometry that drives the contents of the pot 5 to the inside wall 14 of the pot thereby using the inside wall 14 as an opposing surface that lifts food up and over the blade section 8D. Further, the sickle blade 8D stops short of the pot corner so that foods, such as melted chocolate, rice, sauces and the like, has an “escape” path for whatever food product may have piled up there in a push broom fashion.

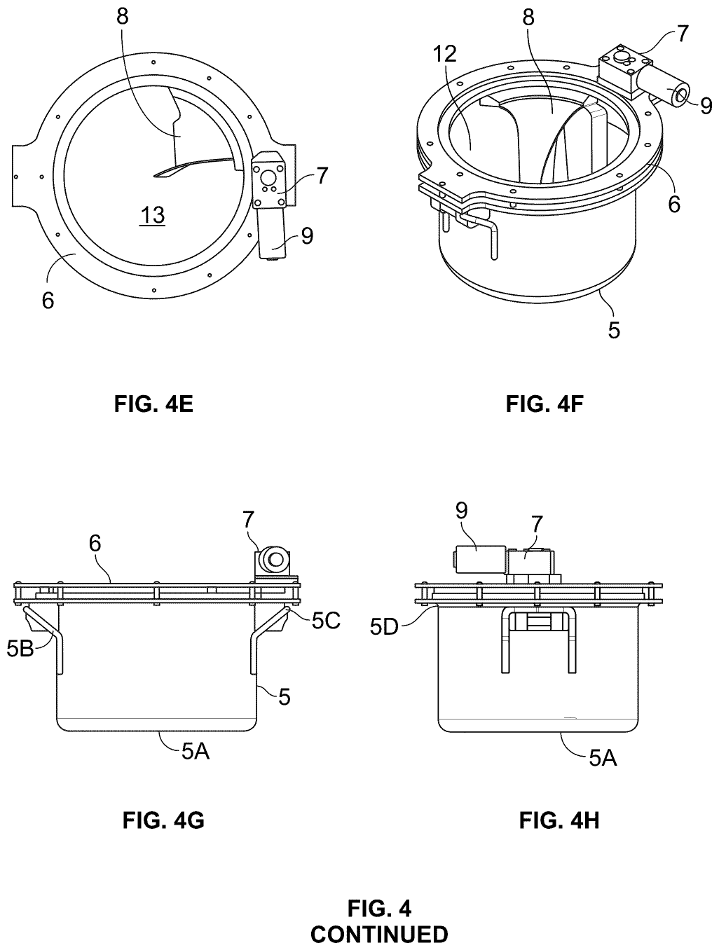

Reference is now made to FIG. 5, depicting the blade assembly 8 in greater detail. Here it can be seen that the blade 8 has a unitary structure that has two main blade arms 8A and 8B and an upper section 8C that would be mounted using any typical securing means to the main ring plate 6. It is the blade assembly 8 that is driven by the ring gear around the inner periphery and bottom of the pot 5. Shown also in FIG. 5 is the bottom scraping blade embodiment section 8D. This scraping blade design is the preferred, but not only, design embodiment. This design has been found to address and solve the main deficiencies of the present state of the art in automated stirring cookware system because this design uses this two-blade system whereby the blade assembly arm 8A wipes the side of the inside of the pot 5 and pushes the contents over back into the middle of the pot while blade 8B wipes the inside bottom of the pot 5 to avoid clumping and spot thickening. This dual simultaneous action of scraping and enveloping creates a motion that flips and folds the contents of the pot to avoid burning while sautéing.

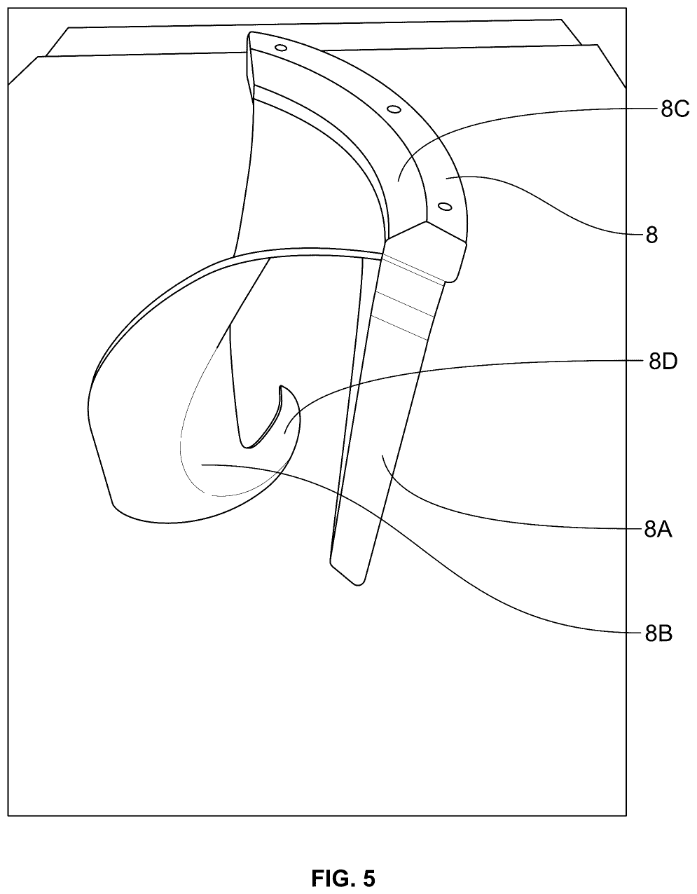

Turning to FIG. 6, there is again shown from a different perspective the current preferred embodiment of the blade assembly 8 having the two blade arms 8A, configured to scrape the insides of the pot and 8B configured to scrape and help fold and flip the contents of the pot in the center. The curvatures of the blade arm 8B is more clearly shown in FIG. 6. It can be better appreciated that these curvatures used for 8B are fairly pronounced such that it creates a consistent stirring of the contents while it pushes the contents and thereby causes the contents to fold up and over, which can be critical in some recipes. This design is not only intended to mimic the motion of an actual human hand in stirring and folding, but allows for a more consistent, even, and well-timed stirring function. As long as there is a power source to run the motor, this stirring does not stop until so desired or otherwise programmed, as discussed below. Therefore, the issues addressed above regarding some users, who may want to do things other than stir, such as socialize with family or guests, tend to other distractions, or whom have physical limitations or just getting tired, are alleviated.

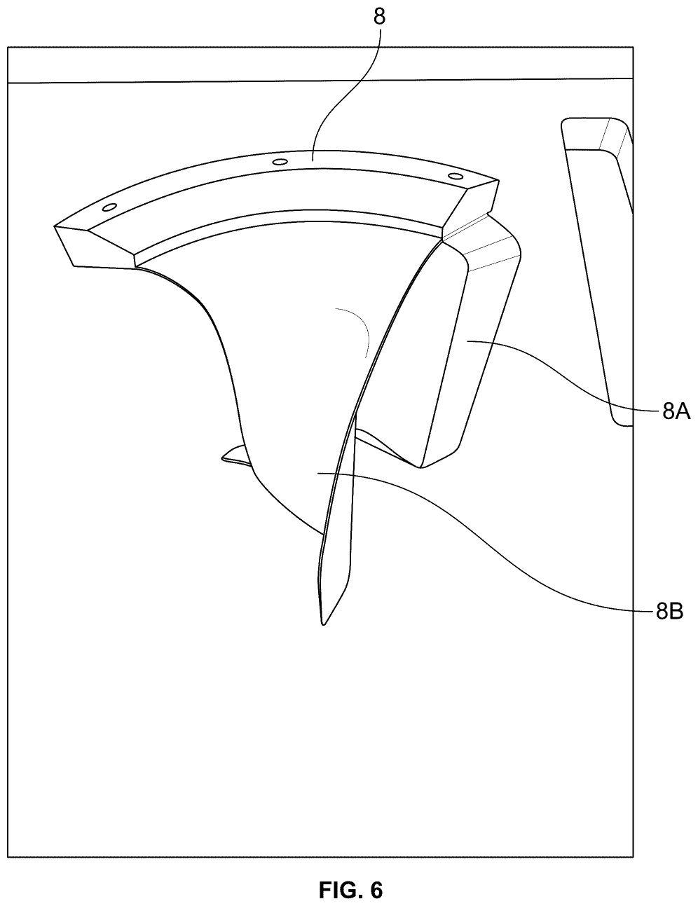

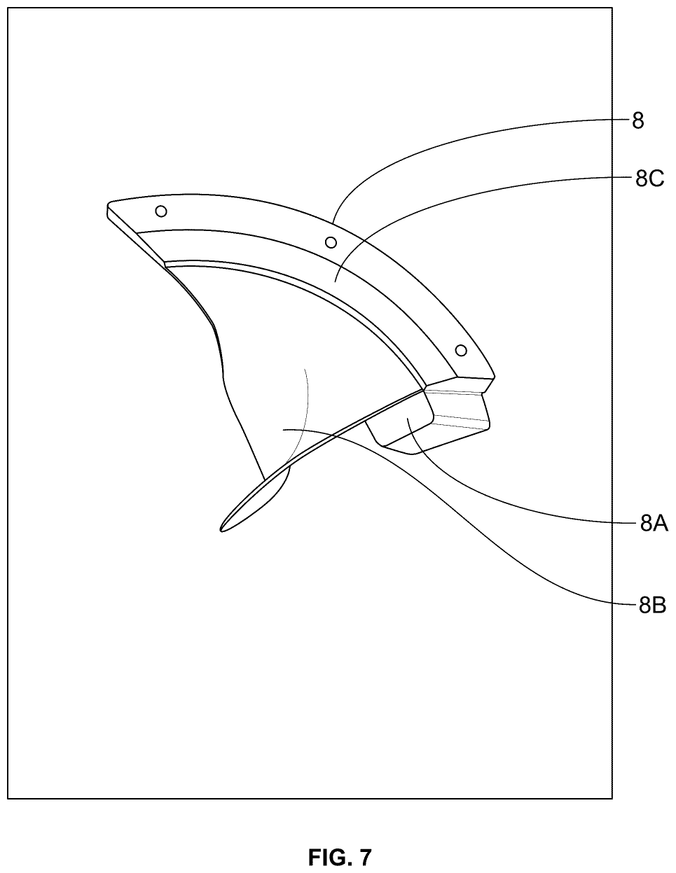

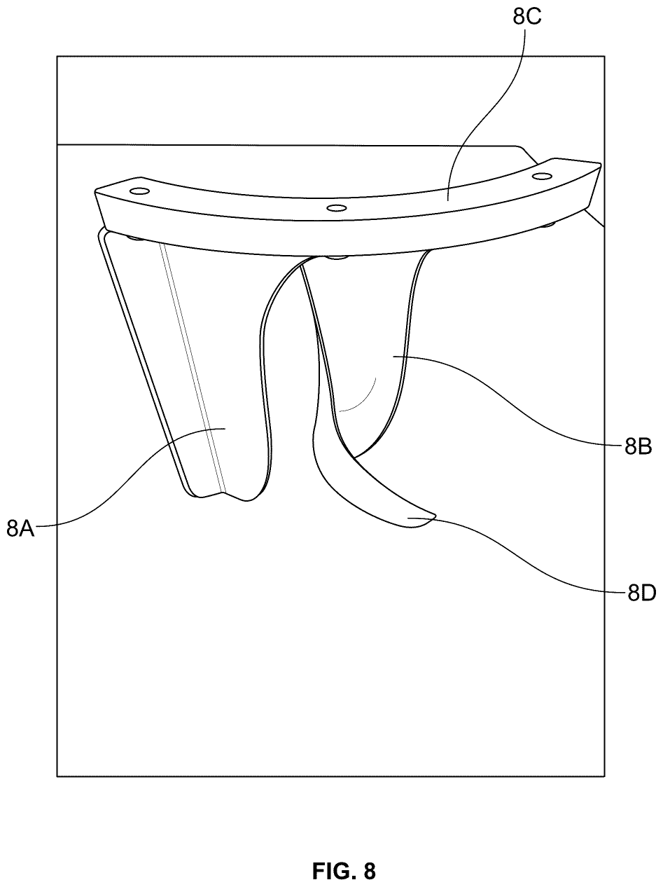

FIG. 7 shows yet another perspective view of the blade 8, this time from the top, while FIG. 8 shows the blade 8 from a perspective that shows the inside design of the blade assembly arm 8A and the blade arm 8B and clearly shows the design of bottom scraping blade section 8D. It can be seen, from these angles, how the bottom scraping blade section 8D should lay in an abutting fashion against the bottom surface of the pot 5. FIG. 9 shows the blade 8 from what is a front view of the blade, again showing blade assembly arm 8A and the blade arm 8B, while also showing the curvature of the lower section of 8B, namely at reference number 8E. This curvature has been found to help create the pushing, folding, flipping and overall stirring function of the blade.

Blade 8 is preferably made of a compliant silicone, rubber or plastic, with an interference fit to the pot surface. As will be understood by persons having ordinary skill in the art, the material used in creating blade 8 can be of other substances which are found to hold-up to heat, are sturdy enough to push, fold, flip and scrape contents that might have some weight but also be pliable/flexible enough to create the preferred interference fit while not getting stuck against the surfaces of the inside of the pot and surviving, in such condition, the heat needed to mix and cook the food contained therein.

In another embodiment, the blade 8 can be separated into two distinct sections where the side wiper is alone on one side and the center and bottom blades stay together as one on the opposite/other side. It will be understood, that in various embodiments, the design of the battery housing and the gear housing can be structured to sit on top of stir-ring 11, within a semi-circular housing located across from battery and gear housings. This design would replace the compartments 4A, 4B, on top of the handles shown in the figures, thereby making the overall look more streamlined. It will be seen that a circular arrangement of cells within the annular housing of the ring gear can function to create a more compact overall package and design while continuing to create the desired result that inspired this design, as noted below, with referenced to FIGS. 10 thru 14.

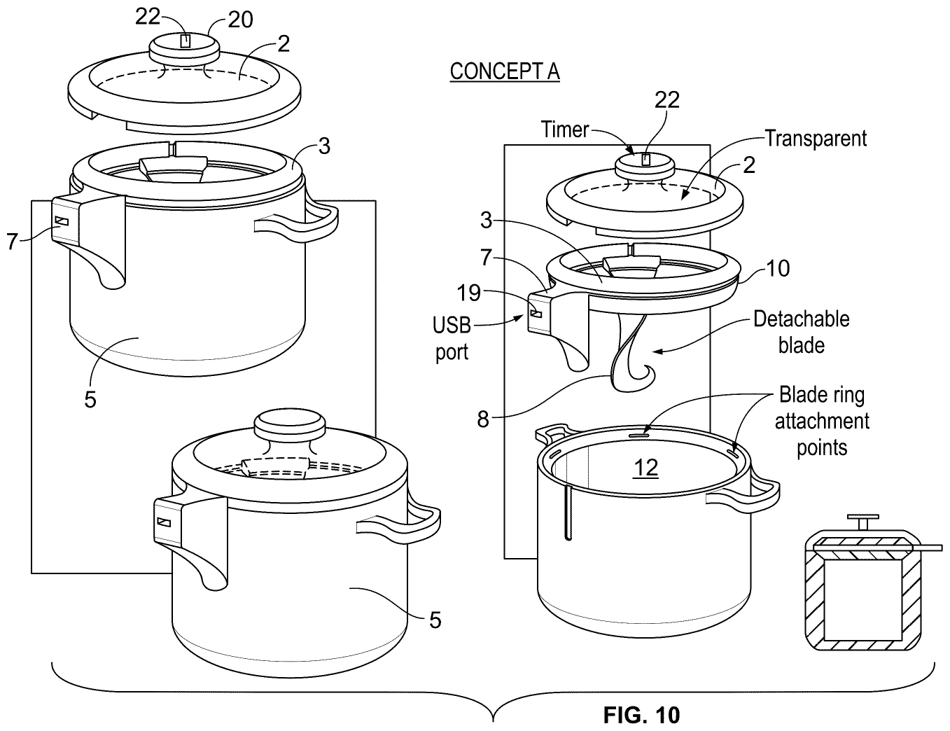

As shown in FIGS. 10 and 11, the present invention shows a transparent cover 2 which itself is of course not new, but fixed onto the cover 2 as the handle/knob 20 is a timer 22. Furthermore, there is included a USB port 14 integrated into the mount 3. It will be understood that any type of electrical connection, including micro-USB port, USB C port, and others, can be substituted for the USB port noted, without departing from the novel scope of the present invention. The device illustrated is meant to assist in recharging a battery (not shown) used to drive motor source 7. The blade 8 is detachable in this embodiment. Also shown is the blade ring 11 onto which the stirring mechanism 10 is mounted and mechanized. It should be noted that the attachment points can be on one side where the three blade designs (stirring, side wiper and bottom wiper) are all together and are attached with several screws into the stir ring structure 10. They may also be split so that those several screws remain to attach the stirring blade 8A and the bottom blade 8D, but the side wiper 8B would be attached with two screws directly across from the other attachment points.

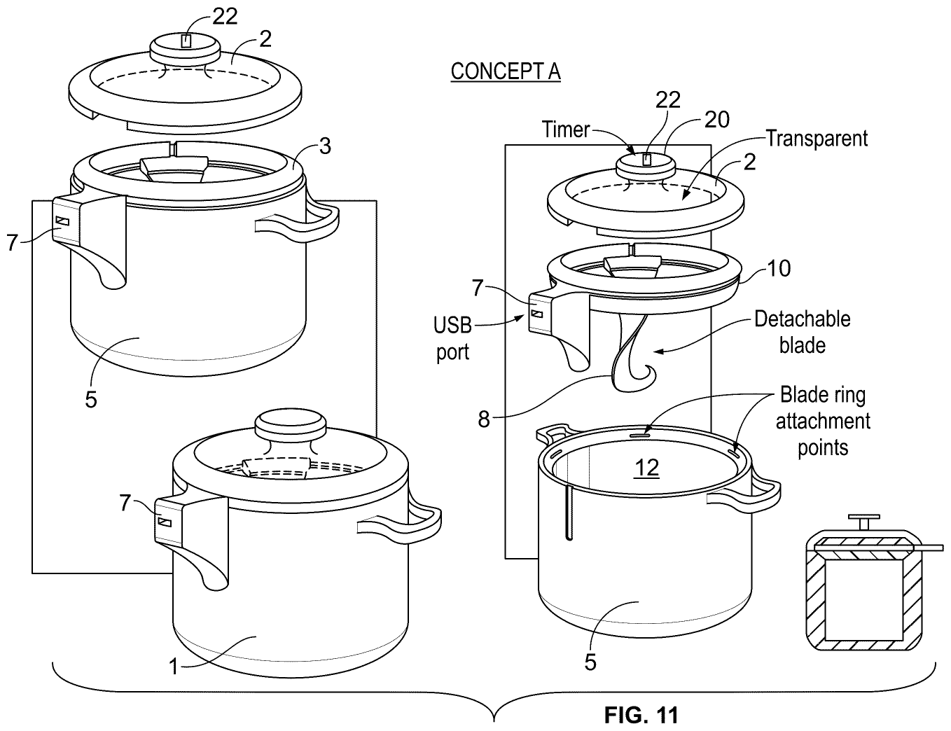

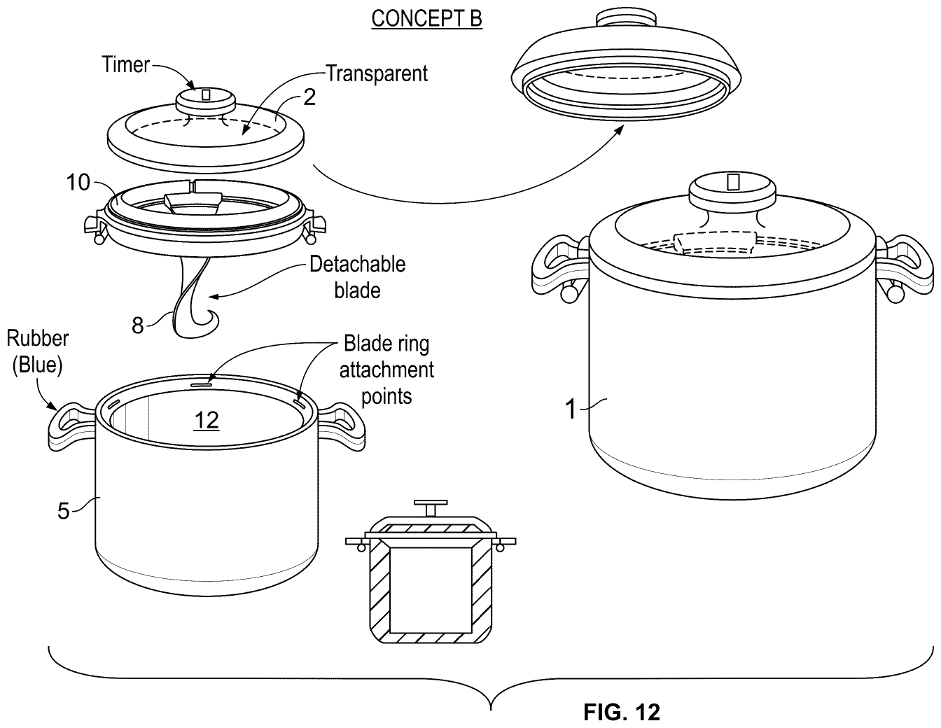

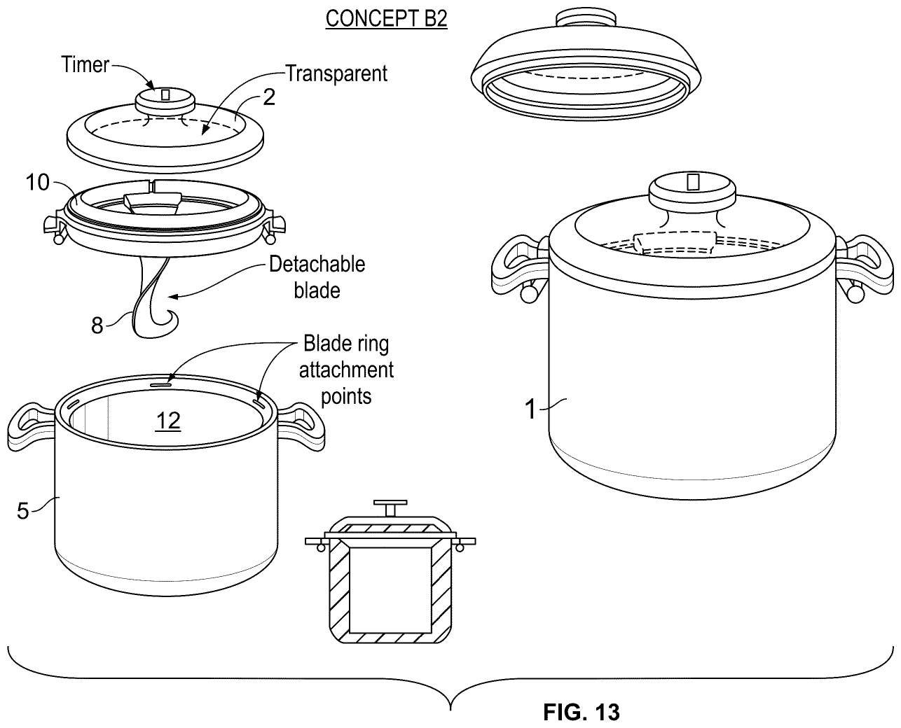

More particularly, FIGS. 10 and 11 depict the motor and battery assembly, also called the blade ring attachment 10 of the present embodiment, that is all built-in and designed to be integrated into the mount 3. These figures also depict, as will be appreciated by persons having ordinary skill in the art, that the blade 8 can be detached (for replacement or to provide a blade having a different profile). Also shown in FIGS. 10-14 are blade ring attachment points to which the mount 3 (or the blade ring attachment means) can be affixed in a manner known to persons having ordinary skill in the art, such as with fasteners such as screws and the like.

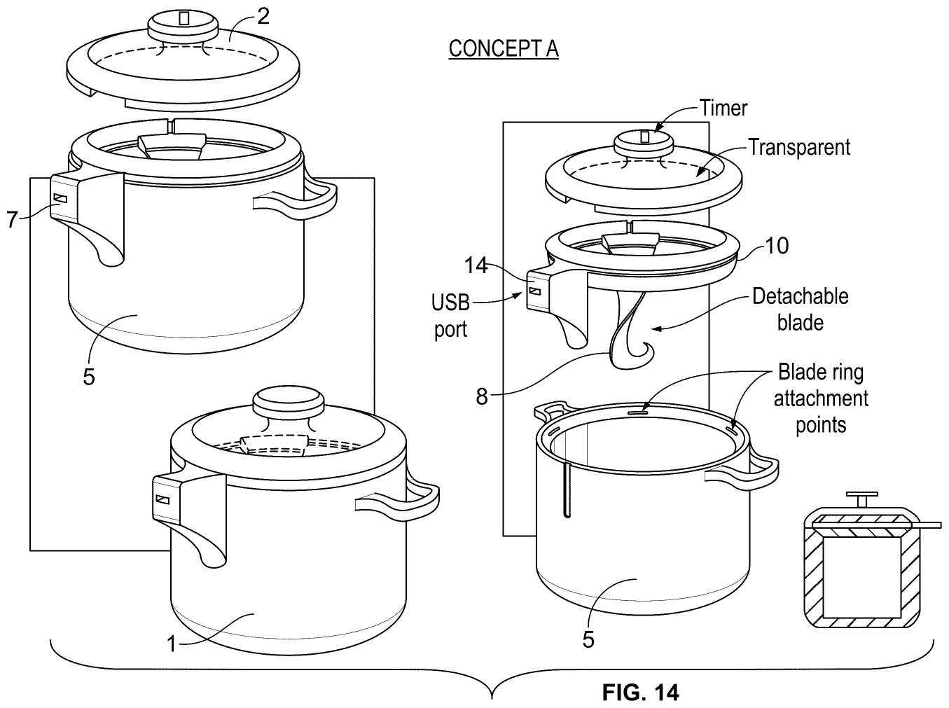

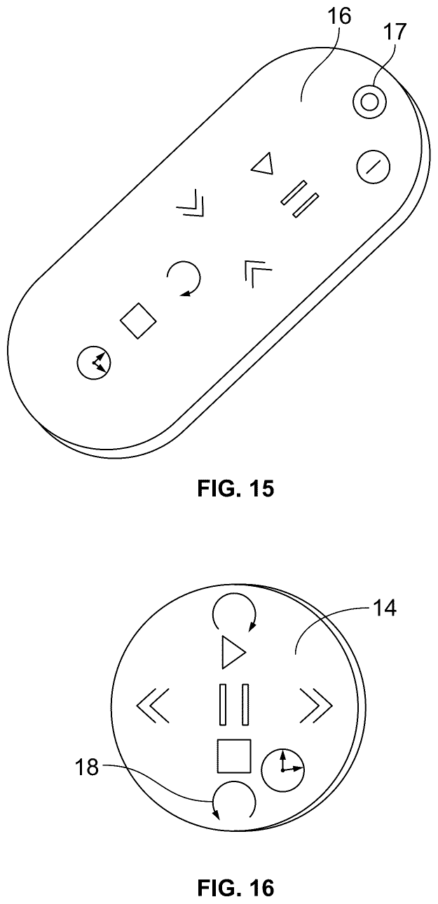

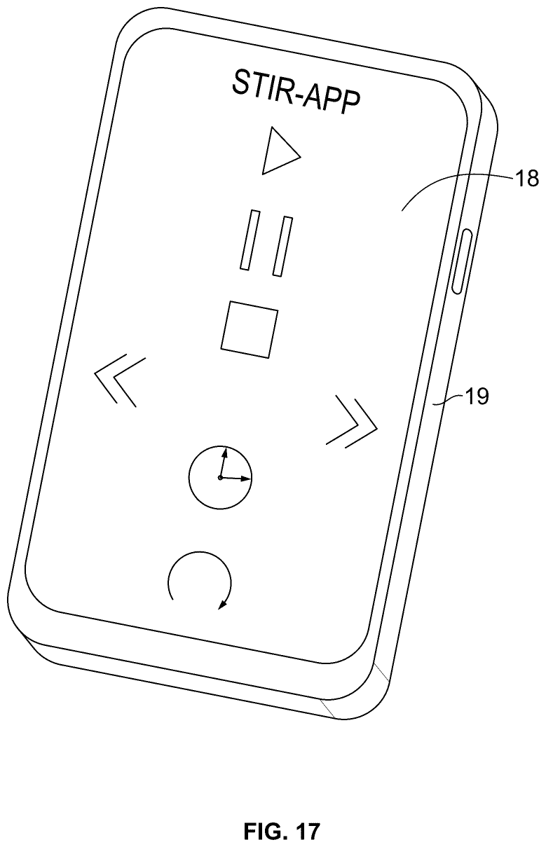

FIGS. 15 and 16 are illustrative of control apparatus for use with any one or more of the devices previously disclosed herein. It will be understood that the drive motor source 7 can have incorporated therein, means, known to persons having ordinary skill in the art, for starting, pausing and stopping the movement of the blades 8, by driving the motor source 7. Additionally, it will be understood that the added refinements of increasing the speed of rotation or reversing the direction and setting a timer to better manage the length of the stirring/mixing period are also operations that the users of the present invention would find convenient. As shown in FIG. 16, a panel having push button controls for these features is provided, in a preferred embodiment, on control panel 14 on pot 1, in a convenient location. Panel 14 can be wired to motor source 7 in a conventional manner to provide the features noted. Referring now to FIG. 15, a remote control 16 is shown having the same, or similar functionality shown in panel 14. Remote control 16 can have a transmitter 17 for sending signals to pot 1, for example to a receiver 18 on panel 14. It will be understood that the received 18 can be located directly on motor source 7 or any other convenient place that allows remote control 16 to act thereon. Additionally, as shown in FIG. 17, the functionality of the present invention can be run using an application 18 on a smart phone or tablet 19. It will also be understood, by persons having ordinary skill in the art, that the type of signal can include any type presently used today, including Bluetooth, WIFI or IR, without departing from the novel scope of the present invention. Symbols on the remote control 16, panel 14 and mobile device application 18 are designed to coincide with symbols typically used, which will be understood by persons having ordinary skill in the art. Through these devices 14 and 16, the device of the present invention can be started, paused, its direction reversed, and the speed of stirring increased or decreased, as desired by the user. Additionally, the remote control 16, allows a user that has a disability or is otherwise fatigued, to control the stirring (including long-term stirring as required by some recipes) without having to rise and walk to the device, in order to modify the process.

While the present invention has been shown and described in the figures, it is capable of embodiment in various forms, and there is described herein the presently preferred and known alternative embodiments. It will be understood that the present disclosure is to be considered as an exemplification of the present invention and is not intended to limit the invention to the specific embodiments discussed or illustrated. Although illustrative embodiments of the invention have been shown and described, it is to be understood that various modifications and substitutions may be made by those skilled in the art without departing from the novel spirit and scope of the invention.

What is claimed is:

1. A self-stirring system for use with a container on a heat source, comprising:
a container, having an interior portion having an inner surface comprising a continuous wall of a desirable height and a floor, for holding one or more substances to be mixed; element having a motive means and at least one dependent blade for folding together one or more substance within the container, the dependent blade having a blade profile comprising an advantageous length and width such that an element of the blade profile is in continuous contact with the inner surface wall of the container and is contiguous with the inner
a stirring surface floor of the container, to substantially continuously mix the substance for a desired time while the substance is affected by the heat source.

2. The self-stirring system of claim 1, wherein the motive means includes a motor and gear assembly.

3. The self-stirring system of claim 1, where the at least one blade is a first blade and a second blade, each of which being advantageously placed to affect a volume of the one or more substances to be mixed.

4. The self-stirring system of claim 3, where the first blade comprises an element having several surfaces configured to lift and fold the one or more substances to be mixed.

5. The self-stirring system of claim 3, where the second blade comprises a flexible element configured to continuously contact the inner surface of the container along its entire height, so as to cause the one or more substances to be mixed to be pushed off of the wall, and a volume adjacent the wall, and towards the first blade.

6. The self-stirring system of claim 3, where one or both of the first blade and the second blade includes a foot element, adjacent to the floor of the container, to lift the one or more substances to be mixed from the floor of the container so as to better mix the one or more substances to be mixed.

7. The self-stirring system of claim 3, where the first blade and the second blade are attached to a toothed gear ring, sustained about the top circumference of the container, in mechanical engagement with the motive means, to cause the first blade and the second blade to effectually rotate about the interior portion of the container.

8. The self-stirring system of claim 1, where the stirring element is controllable by a remote control device, such that the rotation of the at least one dependent blade can be at least started, sped up, slowed down, reversed or stopped remotely.

9. The self-stirring system of claim 1, where the stirring element is controlled by a control panel on the device.

10. A self-stirring system, comprising:
a container, having an inner surface comprising a generally horizontal surface and a cylindrical surface generally perpendicular to the generally horizontal surface, for holding substances to be mixed;
a stirring element having a motive means, comprising a motor and gear assembly controlled by a panel on the self-stirring system, and at least one dependent blade for mixing a substance within the container, the dependent blade having a blade profile comprising a suitable length and width such that an element of the blade profile is in continuous contact with the inner cylindrical surface of the container and is contiguous with the generally horizontal surface of the container, to substantially continuously mix the substance for a desired time.

11. The self-stirring system of claim 10, where the at least one dependent blade is a first blade and a second blade, attached to a toothed gear ring, sustained about the top circumference of the container, in mechanical engagement with the motive means, each blade being advantageously placed to affect a volume of the one or more substances to be mixed.

12. The self-stirring system of claim 11, where the first blade comprises, an element having several surfaces configured to lift and fold the one or more substances to be mixed.

13. The self-stirring system of claim 11, where the second blade comprises, a flexible element configured to continuously contact the inner surface of the container along its entire height, so as to cause the one or more substances to be mixed to be pushed off of the wall, and a volume adjacent the wall, and towards the first blade.

14. The self-stirring system of claim 11, where one or both of the first blade and the second blade includes a foot element, adjacent to the floor of the container, to lift the one or more substances to be mixed from the floor of the container so as to better mix the one or more substances to be mixed.

15. The self-stirring system of claim 1, where the stirring element is controllable by a remote-control device, such that the rotation of the at least one dependent blade can be at least started, sped up, slowed down, reversed or stopped remotely.
